(19) United States
(12) Patent Application Publication
(10) Pub. No.: US 2014/0136553 A1
(43) Pub. Date: May 15, 2014

(54) APPLIANCE FOR ACCELERATING GRAPH DATABASE MANAGEMENT AND ANALYTICS SYSTEMS

(71) Applicant: INTERNATIONAL BUSINESS MACHINES CORP, Armonk, NY (US)

(72) Inventors: Arpith C. Jacob, Dobbs Ferry, NY (US); Jude A. Rivers, Cortlandt Manor, NY (US)

(73) Assignee: INTERNATIONAL BUSINESS MACHINES CORPORATION, Armonk, NY (US)

(21) Appl. No.: 13/675,098

(22) Filed: Nov. 13, 2012

(51) Int. Cl. G06F 17/30

(52) U.S. Cl. 707/754; 707/E17.03; 707/E17.005

(57) ABSTRACT

A query on a graph database can be efficiently performed employing a combination of an abstraction program and a graph analytics appliance. The abstraction program is generated from a query request employing an abstraction program compiler residing on a computational node, and includes programming instructions for performing parallel operations on graph data. The graph analytics appliance receives or generates the abstraction program, and runs the abstraction program on data fetched from a graph database to generate filtered data that is less than the fetched data. The filtered data is returned to the computational node. The bandwidth between the graph database and the graph analytic engine can be greater than the bandwidth between the computational node and the graph analytic engine in order to utilize processing capacity of the graph analytics appliance.

### RELATED APPLICATIONS

The present application is related to a copending application Ser. No. ______ (Attorney Docket No. YOR920120684US 1, the entire contents of which are incorporated herein by reference.

### BACKGROUND

The present disclosure generally relates to heterogeneous computer computation and appliances for the same. Specifically, the present disclosure relates to an appliance to accelerate graph database management and graph analytic systems and a method of employing the same.

Though systems like Cray's multi-threaded architecture (MTA) are designed to execute irregular algorithms more efficiently than traditional computer architectures, these systems tend to be for large scale supercomputing and have hard-to-use programming abstractions. Memory bound and irregular algorithms may not fully and efficiently exploit the advantages of conventional cache memory-based architectures. Furthermore, the cache memory and other overheads associated with general-purpose processors and server systems contribute to significant energy waste. Examples of such algorithms include graph processing algorithms, semantic web processing (graph database management system (DBMS)), and network packet processing.

With single-core clock frequency remaining stagnant as power constraints have limited scaling, it has become imperative that irregular algorithms will be better served in parallel multiple core processing environments. Programs need to be rewritten to run in parallel on multicore architectures to meet performance objectives. However, there is as yet no efficient, popular, parallel programming abstraction that a programmer can use productively to express all kinds of program parallelism. Furthermore, it is not clear whether traditional shared-memory homogeneous multicores can continue to scale exponentially over the next decades while maintaining the current power-performance budget. Recent trends suggest that asymmetric and heterogeneous multicores with application-specific customizations and even fixed-function accelerators will be required to meet power-performance goals.

Thus, algorithms known in the art tend to have large amounts of irregular data-parallelism that are difficult for conventional compilers and microprocessors to exploit.

### BRIEF SUMMARY

The present disclosure provides a method, an apparatus, and a system for analyzing graph data for use with general purpose server systems. An easy-to-use programming abstraction is employed with fine-grained multi-threaded message passing schemes that efficiently exploit data parallelism.

A query on a graph database can be efficiently performed employing a combination of an abstraction program and a graph analytics appliance. The abstraction program is generated from a query request employing an abstraction program compiler residing on a computational node, and includes programming instructions for performing parallel operations on graph data. The graph analytics appliance receives or generates the abstraction program, and runs the abstraction program on data fetched from a graph database to generate filtered data that is less in data volume than the fetched data. The filtered data is returned to the computational node as an answer to the query request. The bandwidth between the graph database and the graph analytic engine can be greater than the bandwidth between the computational node and the graph analytic engine in order to utilize processing capacity of the graph analytics appliance.

According to an aspect of the present disclosure, an apparatus for performing a query on a graph database is provided. The apparatus includes a computational node, an abstraction program compiler, and a graph analytics appliance. The computational node includes one or more processor units and is configured to receive a query request. The abstraction program compiler resides on the computational node or on the graph analytics appliance, and is configured to generate an abstraction program from the query request. The abstraction program includes programming instructions for performing parallel operations on graph data. The graph analytics appliance is configured to receive the abstraction program from the computational node, and to fetch data from a graph database according to instructions in the abstraction program, and to run the abstraction program on the fetched data to generate filtered data that is less in data volume than the fetched data, and to return the filtered data to the computational node as an answer to the query request.

According to another aspect of the present disclosure, a method of performing a query on a graph database is provided. A query request is provided at a computational node including one or more processor units. An abstraction program is generated employing an abstraction program compiler residing on the computational node. The abstraction program includes programming instructions for performing parallel operations on graph data. Data is fetched from a graph database to the graph analytics appliance according to instructions in the abstraction program. Filtered data that is less in data volume than the fetched data from the fetched data in the graph analytics appliance is generated by running the graph analytics appliance. The filtered data is transmitted from the graph analytics appliance to the computational node as an answer to the query request.

### BRIEF DESCRIPTION OF SEVERAL VIEWS OF THE DRAWINGS

FIG. 1A is a schematic illustration of an exemplary graph database management system for providing an accelerated query on a graph database that provides filtered data according to an embodiment of the present disclosure.

FIG. 1B is a schematic illustration of internal components of a graph analytics appliance according to an embodiment of the present disclosure.

FIG. 2 is a flow chart illustrating the operational steps during a graph analytic query employing the exemplary graph database management system of the present disclosure.

FIG. 3 schematically illustrates a computation over a directed graph with five vertices, A to E.

FIG. 4 illustrates two primitives, flo and ebb, for vertex C.

FIG. 5A shows an algorithm for the computation that executes at every invocation of a vertex asynchronously.

FIG. 5B shows an algorithm for the computation that executes at every invocation of a vertex synchronously.

FIG. 5C illustrates examples of flo and ebb functions for breadth first search (1), single source shortest path (2), and page rank (3).

FIG. 6 presents a program template in an abstraction according to an embodiment of the present disclosure.

FIG. 7 illustrates a high level organization of a graph database appliance that can be embodied in a field-programmable gate array (FPGA) according to an embodiment of the present disclosure.

FIG. 8 illustrates a high level organization of a system incorporating multiple graph analytics appliances.

FIG. 9A represents a pictorial and textual representation of an exemplary query pattern for targeted advertising.

FIG. 9B represents a textual representation of an exemplary query pattern for targeted advertising.

FIG. 10A represents a pictorial and textual representation of an exemplary query pattern for recommending similar groups.

FIG. 10B represents a textual representation of an exemplary query pattern for recommending similar groups.

### DETAILED DESCRIPTION

As stated above, the present disclosure relates to an appliance to accelerate graph database management and graph analytic systems and a method of employing the same. Aspects of the present disclosure are now described in detail with accompanying figures. It is noted that like reference numerals refer to like elements across different embodiments. The drawings are not necessarily drawn to scale.

Data analytics on linked or graph data is becoming extremely important in the business and scientific communities. Examples of linked data include: person to person relationships, protein/chemical networks, metabolic pathways, linked webpages, semantic web resource description framework (RDF) data, telephone call records, credit card transactions, user to internet protocol addresses of websites visited, visitor advertisements, etc. In particular, linked or graph data is rapidly exploding on the web, especially with the advent of social networks and media.

These graph analysis applications include detecting cliques or subgraph matching in protein homology networks, recommending points of interest, discovering musical entities through relationships, mining biomedical pathways, exploring research communities, analyzing streaming sensor data such as Twitter™ feeds, and matching display ads to users in low latency advertising exchanges. It is expected that the storage of linked data and efficient extraction of information from it, i.e., the online analysis of linked data, is bound to have important social, business and commercial implications.

Conventional processors are power and performance inefficient for graph analytics due to i) poor data locality, resulting in limited reuse of data and rendering on-chip cache memory expensive; ii) synchronization and sharing requirements between threads across sockets, potentially degrading performance due to coherence overhead; and iii) high data access-to-computation ratios, due to high latency from the central processing memory to the main memory.

Furthermore, performance falls precipitously if the graph is stored in or overflows to conventional storage media beyond main memory (such as redundant array of independent disks (RAID) or flash memory) because the network link bandwidth between the general-purpose processor and storage media can be extremely limited, causing a major bottleneck. Overcoming these challenges require hardware support to hide latency, algorithm-specific modifications to minimize locking, and non-portable program customizations applied on a case-by-case basis. Despite these optimizations, inefficiencies may still remain. The present disclosure seeks to propose an appliance for accelerating a graph database management system as well as graph algorithm-based analytics systems.

While graph analytics can be executed on an FPGA-based appliance for accelerating relational database management systems, it remains an unnatural fit and expensive computational endeavor. This is because the fundamental operation in a graph algorithm is edge traversal. Edge traversal is an expensive join operation on tables in FPGA-based appliances for accelerating relational database management systems or conventional relational database management (RDBMS) systems paradigm. Hence, graph analytics cannot be efficiently accelerated in any of the traditional database systems currently available.

A popular standardized format for storing graph data on the web is the Resource Description Framework (RDF). The fundamental data structure in the format is a <subject, predicate, object> triple, i.e., a representation of a graph edge between the subject and object computational nodes labeled by a predicate. The semantic web project by Bizer et. al., The story so far, Int. J. Semantic Web Inf. Syst. Vol. 5, Issue. 3, pp. 1-22, has led to the adoption of RDF by a large group of actors including various governmental organizations, life sciences companies, media organizations, libraries, and others. Recent analysis estimates a 53× increase in RDF tuples between 2007 and 2010. If this rapid growth trend continues, the computational storage and analysis of graph data is bound to emerge as a significant challenge.

Structured Protocol And Resource description framework Query Language (SPARQL) is a W3C standardized language developed to analyze linked data on the web. SPARQL is a declarative language, similar to SQL for relational databases that can be used to execute simple graph pattern matching queries. More capable extensions of the language allow description of rich subgraph patterns as queries.

An appliance to accelerate graph database management and graph analytic systems is provided according to an embodiment of the present disclosure. In one embodiment, graph processing, i.e., edge traversal and subgraph matching queries, is abstracted through a high-level SPARQL program extension and the resulting modified queries are then offloaded to a specialized engine close to storage for execution.

In one embodiment of the present disclosure, a specialized appliance system is provided that can efficiently accelerate edge traversal, executing queries represented in the current SPARQL language plus an abstraction extension of the language. This targeted abstraction language is herein referred to as X*, which can be a superset of the current SPARQL language. In one embodiment, the appliance, incorporating a special-purpose (which could be an FPGA-based or ASIC-based) processing engine attached to a storage device, will then traverse edges in the stored graph data and only select vertices and edges that pass certain matching criteria. Only the small matching subset of vertices and edges would be returned to the requesting computational node client. The appliance can be placed before the traditional main memory or after the traditional main memory, and is placed before a storage device (such as RAID, flash memory, etc.).

The abstraction program compiler can be resident within a graph analytics appliance (or an “appliance” in short) within a computational node that is the host originating the graph algorithmic query. If the abstraction facility is resident at the host processor with SPARQL, then the resulting query that is sent over the link network to the appliance is already in the form that the appliance understands and executes directly. If the abstraction program compiler is resident within the appliance, then the query sent from the host over the link network to the appliance will be the traditional SPARQL and the necessary primitive extensions. The query is then compiled and transformed by the abstraction program compiler and executed on the processing engine in the appliance.

The abstraction language and processing engine adopted in the present disclosure can be employed in conjunction with a graph database management and a graph analytics appliance. The resulting appliance will significantly boost performance, increase power efficiency, and provide better system throughput. In one embodiment of the present disclosure, it is possible to execute analytics queries on large graphs and receive a response at significantly lower latencies than currently possible, providing a competitive advantage for emerging online applications such as advertising exchanges.

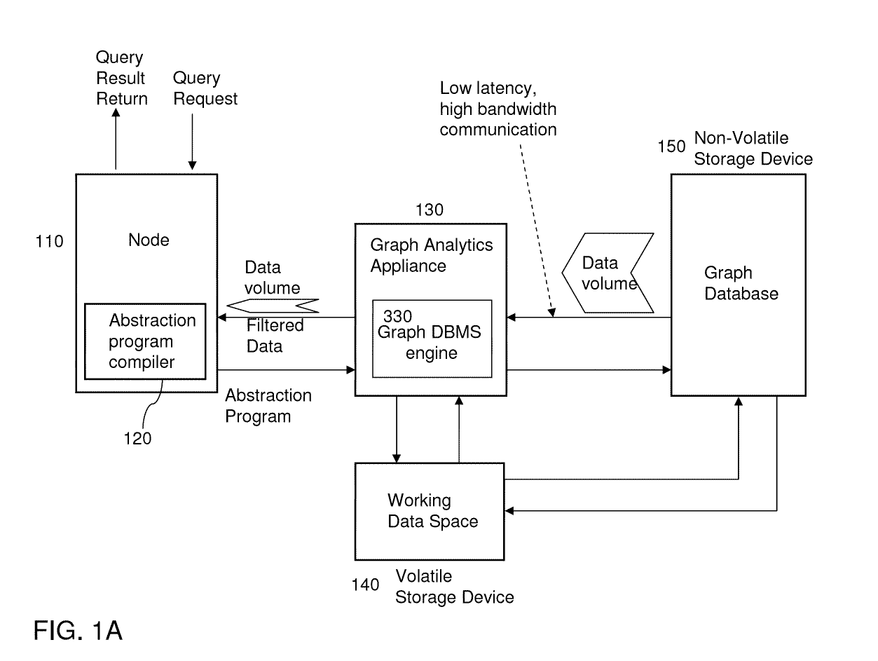

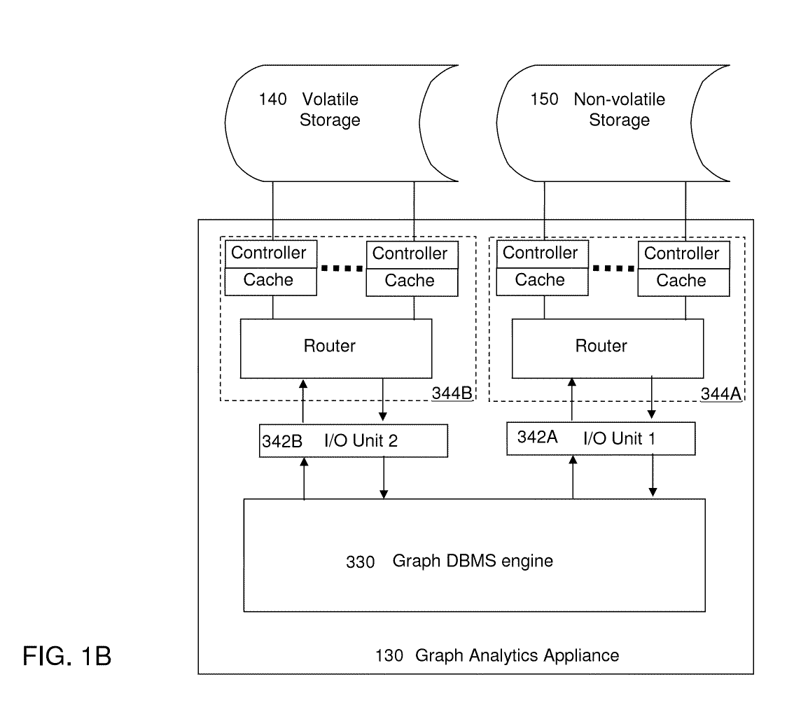

Referring to FIGS. 1A and 1B, a pictorial representation of an apparatus according to an embodiment of the present disclosure is shown. The system includes a computational node 110, which can be a general purpose computational node modified with the installation of an abstraction program compiler 120. The system further includes a graph database 150, which is embodies in a non-volatile storage device, i.e., a data storage device that preserves data indefinitely even in case of a disruption to the power supply thereof. The system further includes a volatile data storage device 140, i.e., a data storage device that loses data in case of a disruption to the power supply thereof. The volatile storage device 140 functions as a working data space for a graph analytics appliance 130, which analyzes data fetched from the graph database 150. For example, the volatile data storage device can be a static random access memory (SRAM) device.

The computational node 110 can be in a standalone computer or in a server suite. The computational node 110 generates or receives a query request on a graph database, which is herein referred to as a graph database query. In one embodiment, the query request can be in the SPARQL format. The computational node 110 forwards the query request to a graph analytics appliance 130 in the form of an abstraction program, which is herein referred to as the X* program. An abstraction program compiler residing in the computational node 110 compiles and transforms the query request, which can be a SPARQL query, into a form understandable by the graph analytics appliance 130, which is an analytics engine.

The abstraction program compiler 120 is an abstraction facility, i.e., an analytics engine appliance, and as such, could either be resident and running on the computational node 110 or resident and running on the graph analytics appliance 130.

The graph analytics appliance 130 is located close to the graph database 150 in terms of data accessibility and communication bandwidth. The graph analytics appliance 130 continues to fetch the necessary data from the graph database 150 into the working data space provided in the volatile storage device 140, while continuously working on the fetched data to compute the appropriate subsets of the graph stored in the graph database 150 to be sent back to the computational node 110 in response to the query request (as an answer to the query request). In one embodiment, the volatile storage device 140 can be incorporated within the graph analytics appliance 130.

The computational node 110 includes one or more processor units therein, and is configured to receive or generate a query request. The abstraction program compiler 120 can reside on the computational node 110 or on the graph analytics appliance. The abstraction program compiler 120 is configured to generate an abstraction program from the query request. The abstraction program includes programming instructions for performing parallel operations on graph data. The graph analytics appliance 130 is configured to receive the abstraction program from the computational node 110. Further, the graph analytics appliance 130 is configured to fetch data from the graph database 150 according to instructions in the abstraction program. Yet further, the graph analytics appliance 130 is configured to run the abstraction program on the fetched data to generate filtered data. The data volume of the filtered data is less in data volume than the data volume of the fetched data. As used herein, data volume is measured in the total number of bytes representing the corresponding data. The graph analytics appliance 130 is configured to return the filtered data to the computational node 110 as an answer to the query request.

The volatile storage device 140 is in communication with the graph analytics appliance 130, and is configured to store therein the fetched data from the graph database 150. In one embodiment, the graph analytics appliance 130 can be configured to fetch data directly from the graph database 150 and to subsequently store the fetched data in the volatile storage device 140. Alternately or additionally, the graph analytics appliance 130 can be configured to fetch data from the graph database 150 through the volatile storage 140 into the graph analytics appliance 130. Further, the volatile storage device 140 can be configured to store at least one temporary data structure generated from the fetched data prior to generation of the filtered data.

In one embodiment, the graph analytics appliance 130 can be configured to generate a plurality of input/output (I/O) requests to the graph database 150. The graph analytics appliance 130 includes a graph database management system (DBMS) engine 330. The graph DBMS engine 330 includes at least one processing unit therein, and is configured to receive the abstraction program from, and to transmit the filtered data to, the computational node 110.

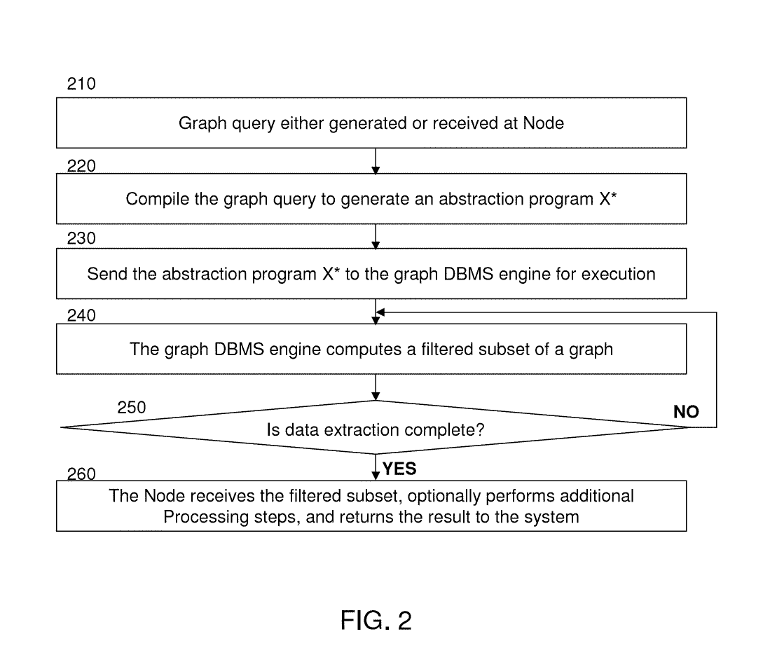

As shown in FIG. 2, the graph analytics appliance 130 can include a first input/output unit 342A configured to receive input/output (I/O) requests from the graph DBMS engine 330, and a first set of I/O peripheral devices 344A configured to relay the I/O requests between the first I/O unit 342A and the graph database 150. The volatile storage device 140 is in communication with the graph analytics appliance 130 and configured to store the fetched data therein. The graph analytics appliance 130 can further includes a second input/output unit 342B configured to receive additional input/output (I/O) requests from the graph DBMS engine 330, and a second set of I/O peripheral devices 344B configured to relay the additional I/O requests between the second I/O unit 342B and the volatile storage device 140.

The computational node 110 can be configured to receive the query request in a form of a structured query language (SQL). Further, the abstraction program compiler 120 can be configured to generate the abstraction program in an assembly language for execution on at least one processing unit in the graph analytics appliance 130. In one embodiment, each of the at least one processing unit can be a reduced instruction set computing (RISC) processor unit.

The graph analytics appliance 130 is provided with a first communication channel having a first bandwidth for data transmission between the computational node 110 and the graph analytics appliance 130, and is provided with a second communication channel having a second bandwidth for data transmission between the graph database 150 and the graph analytics appliance 130. The second bandwidth is greater than the first bandwidth. In one embodiment, the second bandwidth is greater than the first bandwidth at least by a factor of 10. For example, the second bandwidth can be greater than the first bandwidth by many orders of magnitude.

In one embodiment, the fetched data from the graph database 150 may be stored in a combination of volatile and non-volatile storage media instead of being stored in a single volatile storage device 140. Thus, the volatile storage device 140 may be substituted with a combination of volatile and non-volatile storage media. Further, the data generated by the graph analytics appliances 130 may be stored in non-volatile storage, either because they are too large to fit in main memory or for long term persistent storage. Non-volatile storage devices, e.g. a flash memory, typically has high capacity, high bandwidth, low access time, and the ability to service large number of concurrent I/O requests as compared to rotating disk media configurations such as SATA (Serial Advanced Technology Attachment) RAID. Note that the use of the (FPGA-based or ASIC-based) graph database processing engine attached directly to the storage media alleviates the bottleneck network link between the storage media and the computational node, because only the vertices and edges matching a query are returned.

The computational node 110 can receive or generate a SPARQL query and forward it on to the graph analytics appliance 130. The graph analytics appliance returns filtered data, but not whole graph segments that cover the scope of the query request. Thus, the data volume of the filtered data returned to the computational node 110 is much less than the data volume of whole graph segments that cover the scope of the query request, which is transferred from the graph database 150 to the graph analytics appliance. In contrast, prior art query methods require direct transmission of the whole graph segments that cover the scope of the query request from a graph database to a computational node, which results in a large data movement into a computational node and requires a long processing time.

In one embodiment, the abstraction program compiler 120 can be located at the computational node 110 or within the graph analytics appliance 130. The abstraction program can be a compiled SPARQL query that has been transformed into the appliance format, i.e., a format such as an assembly language that can be utilized by the graph DBMS engine 330. The graph DBMS engine 330 fetches the necessary data from the graph database 150 while continuously working on the data to compute the minimal appropriate subset of the graph data (i.e., the minimal data that corresponds to the final result of the query request) to send back to the computational node 110 as an answer to the query request. In one embodiment, minimal data that corresponds to the final result of the query request is returned to the computational node 110. Thus, the computational node 110 can merely receive the filtered data without a need to further extract additional data for the query request. Thus, the volume of the data from the graph analytics appliance 130 to the computational node 110 can be relatively small, and the data transfer can be performed in a short time period.

Referring to FIG. 2, a flowchart illustrates a typical graph analytic query through the apparatus of FIGS. 1A and 1B. Referring to step 210, a graph query, i.e., a query to extract data from a graph database, is generated or received at a computational node 110 (See FIG. 1A).

Referring to step 220, the graph query is compiled to generate the abstraction program X* employing an abstraction program compiler 120, which can reside on the computational node 110 or on the graph analytics appliance 130. The abstraction program includes programming instructions for performing parallel operations on graph data to be fetched from the graph database 150 to the graph analytics appliance 130 and the volatile storage device 140.

Referring to step 230, the abstraction program is sent to the graph DBMS engine 330 for execution. The data is fetched from the graph database 150 to the graph analytics appliance 130 and/or the volatile storage device 140 according to instructions in the abstraction program.

Referring to step 240, the graph DBMS engine 330 runs the abstraction program to perform the algorithms encoded within the abstraction program on the fetched data. The graph DBMS engine 330 iteratively computes a filtered subset of whole graph segments that cover the scope of the query request which are transferred from the graph database 150 to the graph analytics appliance 130 and/or the volatile storage device 140. The DBMS engine generates filtered data of a volume that is less than the volume of the entire fetched data that resides in the volatile storage device 140 or in the graph analytics appliance 130.

Referring to step 250, the graph DBMS engine 330 checks if the data extraction is complete. If not, the graph DBMS engine continues the data extraction at step 240.

Referring to step 260, once the data extraction is complete, the filtered data, which is the final result of the query request, is transferred from the graph analytics appliance 110 to the computational node as an answer to the query request.

In an embodiment of the present disclosure, a programming abstraction representing programs that operate on a graph data structure is provided. In one case, a graph may be provided as an input at runtime, and may not be available at compile time. The graph may be distinct from the program, for example, a person-to-person network, or it may be derived from a program, for example, a control flow graph.

A graph includes a set of vertices V, which is herein interchangeably referred to as computational nodes. An edge set E⊂V×V is defined between the vertices. The graph may be undirected or directed, and may contain cycles. A vertex or an edge may have attributes, which we represent using the dot notation. The fundamental attribute that the abstraction operates on is v.val, for a vertex v in V of some user-defined value type val_t.

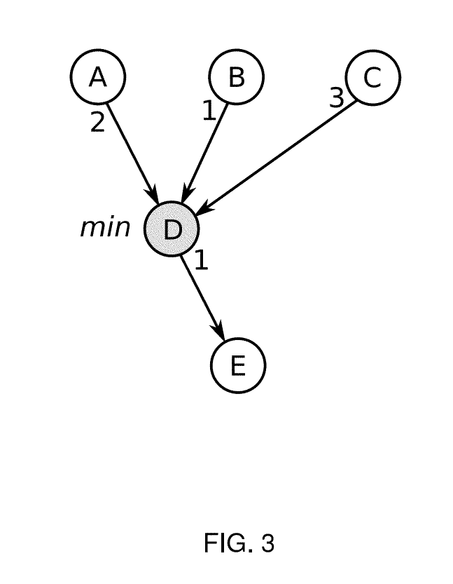

For the purpose of illustration, a simple example of a computation over a directed graph is considered. Referring to FIG. 3, a graph with vertices labeled A to E is shown. The integer value at each directional edge of the graph is the result of a computation at a vertex that corresponds to the starting point of the vertex. Each integer value is then sent as a message along a vertex's outgoing directional edge to the end point of the directional edge. In the initial state, the val attribute of every vertex is initialized to some integer value. During the computation phase, each vertex receives one input value at all of its incoming edges, computes the minimum of these values, and sends the result along every outgoing edge.

There is some parallelism in this computation. For example, vertices A, B, and C may be processed in parallel, however, vertices D and E must be processed sequentially. In order to simplify synchronization, the model requires that an operation on a vertex v must modify that vertex's attribute(s) only. Data sharing between vertices requires sending messages along edges. In an embodiment of the present disclosure, a programming abstraction is provided that implicitly enforces these two requirements and transparently exploits any parallelism available in the graph structure.

In an embodiment of the present disclosure, computation at a vertex may, or may not, be synchronized. Thus, all of a vertex's input values may, or may not, be available before the minimum computation is allowed to proceed.

For illustrative purposes, suppose the first value available at vertex D is 1, received from vertex B. The first available value may be compared to the initial value (in this case a large integer). The algorithm can then decide to send the resulting minimum, 1, along the outgoing edge D→E. This message may in turn trigger computation at vertex E, which proceeds “speculatively.” At some subsequent time the integers 2 and 3 are received at vertex D, which are compared to the most recent result of the minimum computation. Since the two integers are larger, no subsequent messages are sent along the edge D→E. In this case, speculative execution results in a faster program completion time, and the overhead of synchronization at a vertex can be avoided.

Computations that operate on a graph without requiring synchronization at a vertex are herein referred to as asynchronous algorithms. See, for example, Pearce et al., Multithreaded asynchronous graph traversal for in-memory and semiexternal memory, Proc. 2010 ACM/IEEE International Conference for High Performance Computing, Networking, Storage and Analysis. SC '10. pp. 1-11 (2010). Such asynchronous algorithms for breadth first search and connected components run 1.6× to 13× faster than algorithms that synchronize at vertices.

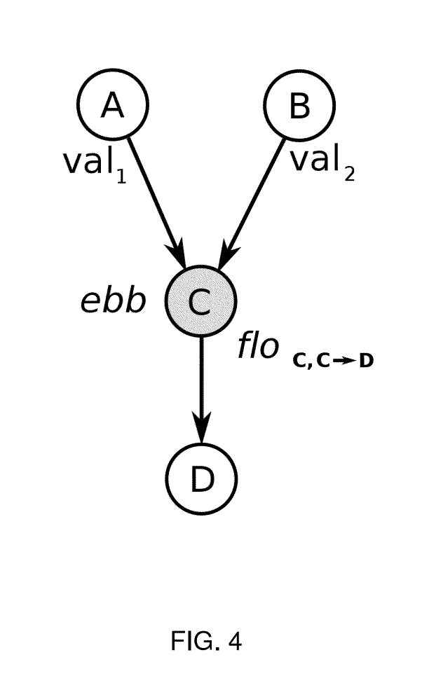

For illustrative purposes, consider functional flo and ebb as two primitive operations on graph data. The function flo_{u,u→v}:val_t→val_t is defined for each vertex u and an outgoing edge u v. It takes a vertex value and returns a value without maintaining state. The ebb primitive defines a binary operator ⊕ that operates on vertex values. ebb is applied to all incoming values (as well as the initial value) of a vertex and the result is stored in the val attribute of the vertex. All vertices' val attributes are assumed to be initialized to the identity of ⊕. The two primitives are shown in FIG. 4 for vertex C.

In general, the abstraction program can include a plurality of parallel threads for running the requested query. Each of the plurality of parallel threads includes an instruction for operating on no more than one vertex in a graph in the graph database. The plurality of parallel threads can include first threads configured to operate on a single vertex and at least one edge in the graph (such as the ebb primitive) and second threads configured to operate only on a single vertex in the graph (such as the flo primitive). In one embodiment, each thread can correspond to a unique vertex in the fetched graph data.

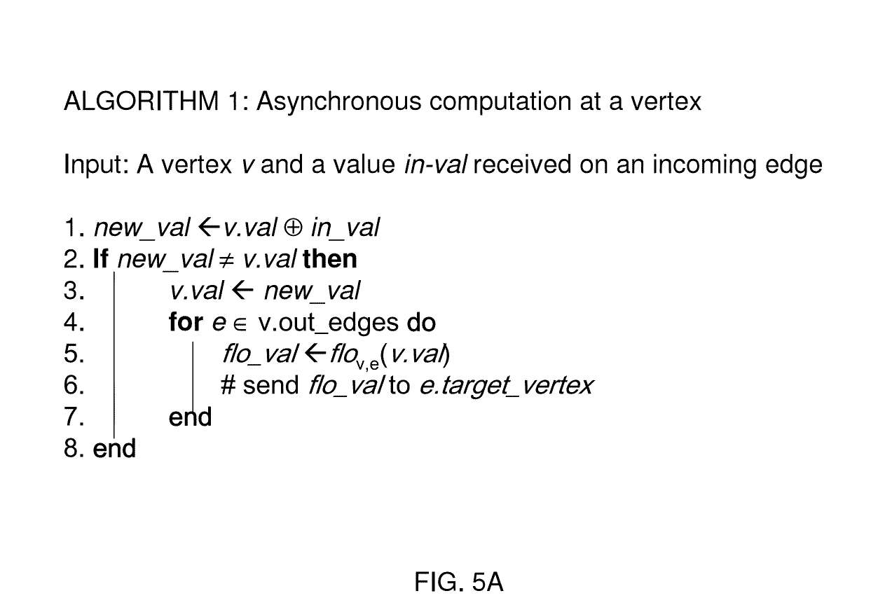

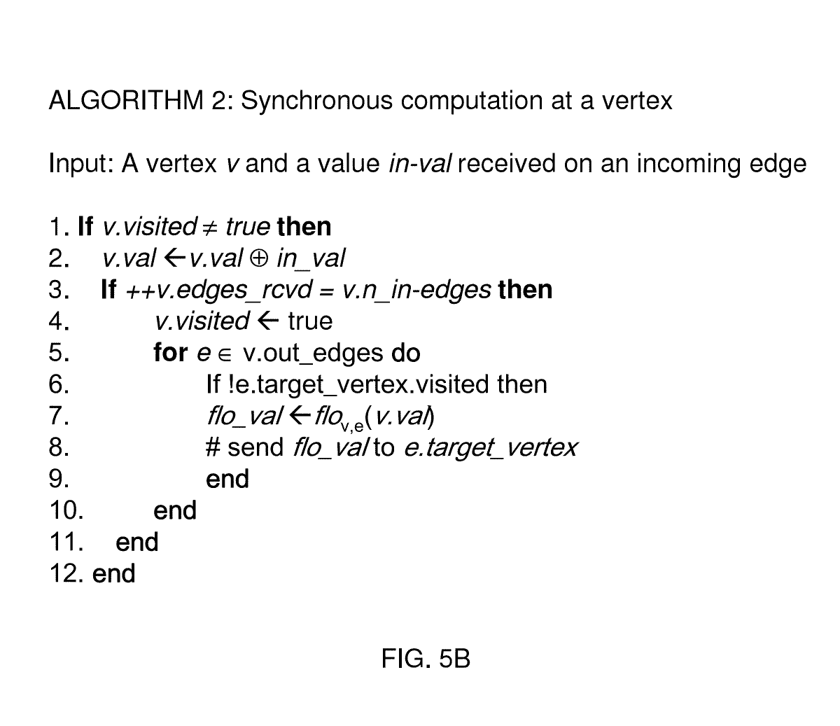

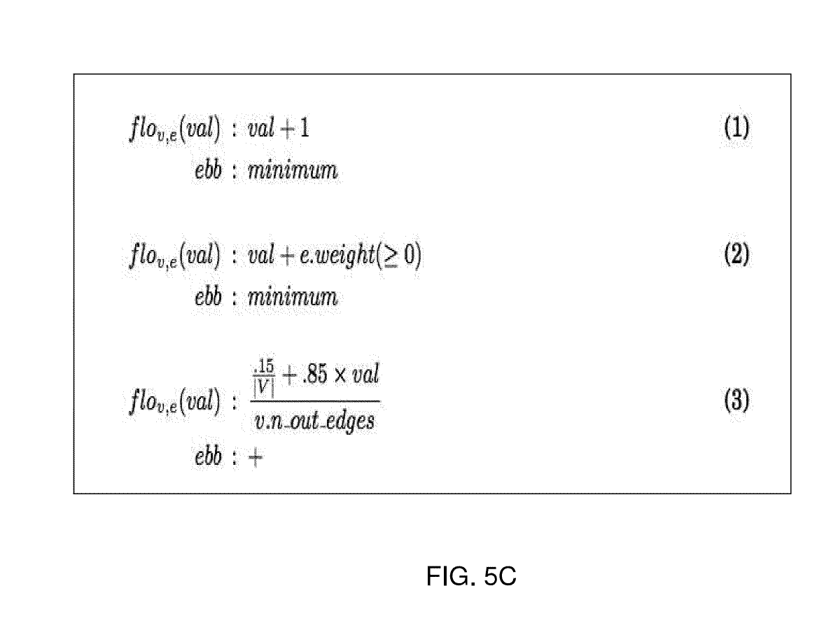

FIG. 5A shows the computation that executes at every invocation of a vertex in the asynchronous case (Algorithm 1). The input to the algorithm is a vertex v and one incoming value in_val. Line 2 of FIG. 5A ensures that a message is sent along a vertex's outgoing edges only if its val attribute has been updated by the incoming edge.

Referring to the processing step of line 1 of Algorithm 1, the ebb function is applied to both the incoming value in_val and the vertex's current value v.val, and the result is stored in a temporary, new_val. Referring to the processing step of line 2 of Algorithm 1, further processing continues only if the computation in the previous step produces a new result (update), otherwise, the algorithm terminates. Referring to the processing step of line 3 of Algorithm 1, the program updates the vertex's value v.val with the new result new_val. Referring to the processing step of line 4 of Algorithm 1, the program loops through all the vertex's outgoing edges, communicating the update. Referring to the processing step of line 5 of Algorithm 1, the flo function, possibly specialized (parameterized) by the vertex and edge, is applied to the new result. Referring to the output step of line 6 of Algorithm 1, the result of the flo function from the previous step is communicated to the vertex v's neighboring vertex.

Algorithm 2 in FIG. 5B shows the synchronous case. A reference count v:edges_rcvd is used to wait until all incoming values have been received. A v:visited Boolean is also used to avoid sending messages along a cycle. Note that, in both algorithms of FIGS. 5A and 5B, it is assumed that the ebb operator is associative and commutative. Appropriate modifications are required if these properties are not satisfied.

Referring to the processing step of line 1 of Algorithm 2, when an incoming value is received at a vertex, processing at that vertex is required only if it has not been visited; this is verified by inspecting the visited field of the vertex. Referring to the processing step of line 2 of Algorithm 2, the ebb function is applied to both the incoming value in_val and the vertex's current value v.val, and the vertex's value v.val is updated with the new result. Referring to the processing step of line 3 of Algorithm 2, further processing at this vertex continues only if similar updates have been received from all of the vertex's incoming edges, otherwise, the algorithm terminates. Referring to the processing step of line 3 of Algorithm 2, if the algorithm has received updates from all of its incoming edges, mark it as visited. Referring to the processing step of line 5 of Algorithm 2, the program loops through all the vertex's outgoing edges, communicating the update. Referring to the processing step of line 6 of Algorithm 2, the update is sent to an outgoing vertex only if it has not been visited. This check eliminates spurious work, for example, by ensuring that an update is not sent on an outgoing edge from the vertex to itself. Referring to the processing step of line 7 of Algorithm 2, the flo function, possibly specialized (parameterized) by the vertex and edge, is applied to the vertex value. Referring to the output step of line 3 of Algorithm 2, the result of the flo function from the previous step is communicated to the vertex v's neighboring vertex.

Both algorithms of FIGS. 5A and 5B execute serially. However, the same computation may execute concurrently on one or more distinct vertices. In one embodiment, this can be the primary means of exploiting irregular data-parallelism using the abstraction method of the present disclosure. The vertex's val attribute is updated without the use of locks, so the runtime must ensure that only one thread operates on a particular vertex at any time. The algorithms enforce an owner-computes rule, where the unique thread that owns (or is assigned to) a particular vertex's data is the one and only one that modifies its value after any associated computation. Due to this property, we are guaranteed that there will never be concurrent updates to the same vertex's data. Because vertex values of neighbors are sent as messages, no other locking mechanism is required to ensure correctness.

FIG. 5C shows examples of flo and ebb functions for breadth first search (1), single source shortest path (2), and page rank (3). It is possible to run breadth first search and single source shortest path asynchronously; page rank must use the synchronous algorithm.

The defined abstraction program can be used to describe irregular data-parallel programs. As used herein, a worklist is defined as an ordered multiset that holds active vertices, i.e., those vertices that require processing. One or more vertices may be added into the worklist during processing of some active vertex. In particular, Lines 6 and 8 of Algorithms 1 and 2 (FIGS. 5A and 5B) respectively add a vertex into the worklist. A vertex is removed from the worklist for processing by a processor. Multiple processors may perform addition and removal operations concurrently on the worklist. It is assumed that there is some mechanism in the implementation of the worklist to ensure consistency.

Vertices in the worklist are ordered by a priority value specified during addition. The priority does not encode a dependency constraint. Instead, the priority specifies a desired execution order that may, for example, speedup convergence of the algorithm, lead to improved data reuse, reduce the maximum size of the worklist at runtime, or in the case of asynchronous algorithms, control speculative execution. Although an implementation may attempt to execute the worklist in prioritized order, this is not guaranteed by the semantics. Hence, a vertex must be added into the worklist only when one or more of its dependencies have been satisfied as is done by the two algorithms in Algorithms 1 and 2 (FIGS. 5A and 5B). Dependent (message) data is specified in a message packet and is associated with a vertex when it is added into the worklist.

Vertices in a worklist may be executed in parallel as follows:
parallel for (eεWorklist) do B(e)
   where B(e) is either Algorithm 1 or 2.

In one embodiment, a particular data structure can be used to efficiently implement the aforementioned abstraction. A worklist W is implemented as a list of n priority queues Qᵢ, 1≦i≦n, such that W=Uᵢ₌¹Qᵢ, and Qᵢ∩Qⱼ=φ for i≠j. A vertex v is added to the queue specified by i=hash(v), where hash is a uniform hash function. Thereafter, elements from each queue may be removed independently. Therefore, prioritized execution is not enforced between vertices in distinct queues. This allows a more efficient implementation of the worklist abstraction. The uniform hash function can be used to distribute work equally among the n queues.

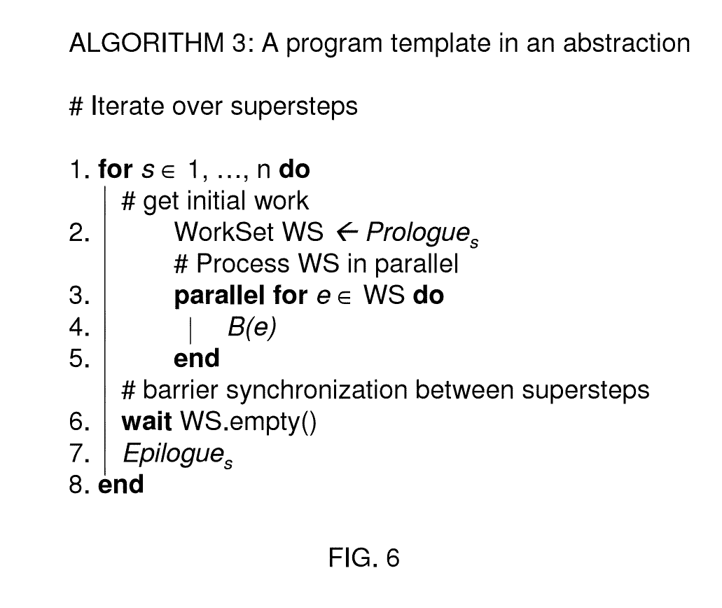

In one embodiment, a program can be written as a serial execution of parallel operations on a graph specified by loops of the kind described above (e.g., “parallel for (eεWorklist) do B(e)”). A parallel loop terminates when the worklist is empty and the system reaches quiescence. This model of execution can be represented compactly as serial executions of loop iterations, called supersteps, as shown in FIG. 6 in Algorithm 3.

Referring to the processing step of line 1 of Algorithm 3, the program is divided into n supersteps that are stepped through serially. Each step is represented by the loop variable s. Referring to the processing step of line 2 of Algorithm 3, the workset WS, which is empty, has to be populated with an initial set of vertices (for example, the root of a tree). This initial set of vertices is computed by the Prologue function, which may be parametrized by s. Referring to the processing steps of lines 3-5, vertices in the workset WS are processed using a parallel for loop to achieve high performance. The computation in line 4 is applied to every vertex in the workset. This computation may in turn add new vertices to the workset. Referring to the processing step of line 6 of Algorithm 3, the synchronization construct in this line waits until all vertices in the workset have been processed and no new vertex is added into the workset. Referring to the processing/output step of line 7 of Algorithm 3, an epilogue stage may aggregate the results and send them to the user for display.

Such an iterative model, called Bulk Synchronous Parallel (BSP), was proposed by Valiant, A bridging model for parallel computation, Commun. ACM 33, pp. 103-111 (199) in order to represent parallel computations. In the BSP model, iterations of the loop are executed serially while the loop body executes in parallel. However, the loop body is composed of two distinct phases that run sequentially. In the computation phase, processors operate in parallel on their local data while in the communication phase there is an exchange of data between processors in preparation for the next superstep. Thus, computation never overlaps with communication. In contrast with the iterative model by Valiant, however, computation and communication are allowed to proceed concurrently in an embodiment of the present disclosure.

A characteristic of the abstraction program according to an embodiment of the present disclosure is implicit synchronization through the enforcement of the owner-compute's rule and data sharing via message passing. As used herein, “data sharing via message passing” refers to a method of communicating shared data generated by a producer thread with one or more consumer threads. In a message passing scheme the producer sends this shared data via one or more messages to the consumers; thus an expensive locking mechanism is not required to ensure consistency. By employing partitioning the vertex computation in this abstraction into a flo and ebb phase, better efficiency can be achieved, for example, in reference counting, through message reduction. As used herein, a “flo,” phase refers to an atomic unit of computation on a vertex value that is possibly parametrized by a vertex and an edge. Examples of flo phases are shown in FIG. 5C. As used herein, a “ebb” phase refers to a binary operator on vertex values. Examples of ebb phases are shown in FIG. 5C.

Having described a programming abstraction to represent irregular algorithms, we next introduce a microprocessor architecture to efficiently execute these algorithms. Graph computation patterns depend on runtime data such as a vertex's outgoing edges, making it difficult for conventional compilers to automatically extract and exploit parallelism from a sequential description of a graph algorithm. Since graphs are typically unstructured and irregular, for example, having a varying number of edges at every vertex, it is difficult to optimally partition computation between cores, limiting scalability. The irregular structure of a graph also limits data locality, which leads to less than ideal performance on conventional cache-backed processors. The fundamental operation in many graph algorithms is graph traversal, and because the computational intensity on a single vertex can be minimal, the data access to computation ratio is higher than regular data-parallel algorithms.

In contrast with methods known in the art, an architecture that addresses the disadvantages of such shared-memory general-purpose processors is provided according to an embodiment of the present disclosure. The distance that data is moved (from disk or DRAM to the ALU) on general-purpose systems leads to considerable energy inefficiency and will likely consume a significant fraction of the power budget of future microprocessors. The long latency to storage necessitates oversubscribing system cores with threads, which may in turn pressure other components of the system (such as coherence traffic), and requires exploiting more concurrency in the application. In the architecture provided by an embodiment of the present disclosure, computation is moved close to storage in terms of data accessibility, improving energy efficiency and eliminating any system bottleneck due to a low bandwidth link to the traditional microprocessor.

Depending on the algorithm and data organization, traditional caches may not be fully exploited. For example, if an edge is associated with multiple attributes, a path traversal algorithm will likely not hit a single cache line more than once, leading to wasted memory bandwidth. This does not mean that there is no data locality that can be exploited, for example, at the page level granularity. Use of large caches could still reduce traffic to the storage controller but a purpose-built solution may be able to make better use of cache resources. The methods of the present disclosure can be particularly useful for algorithms that spend a majority of their time fetching data. The architecture according to an embodiment of the present disclosure can benefit from high-speed context switching of threads. Further, a message passing architecture can be employed to avoid synchronization overhead during data sharing.

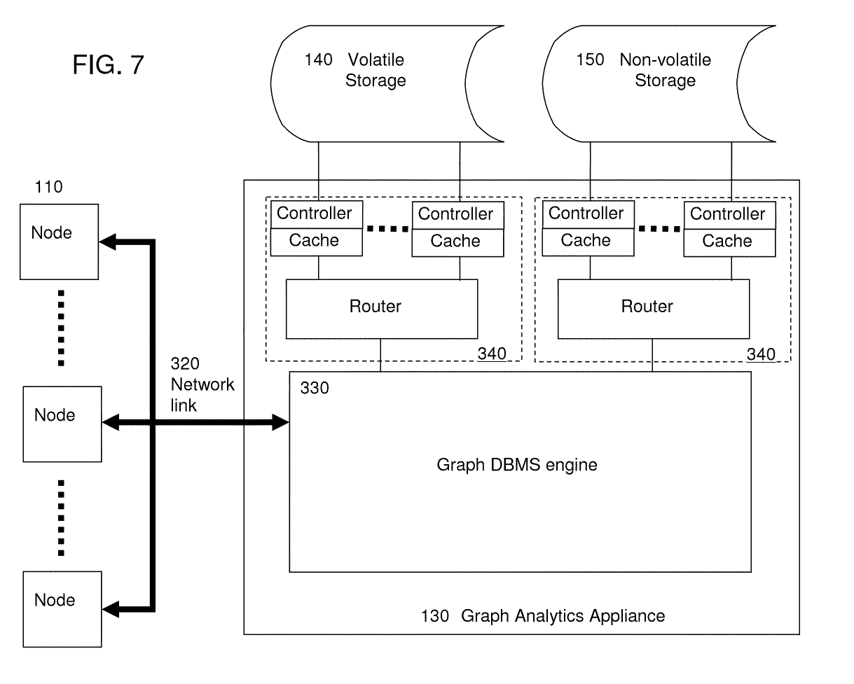

Referring to FIG. 7, a plurality of computational nodes can be employed in conjunction with the graph analytics appliance 130 of the present disclosure. In this case, each of the at least another computational node 110 can include one or more additional processor units, and can be configured to receive or generate another query request. In one embodiment, another abstraction program compiler can reside on one or more of the at least another computational node 110. Each additional abstraction program compiler can be configured to generate another abstraction program from another query request. Further, each additional abstraction program can includes programming instructions for performing parallel operations. The graph analytics appliance 130 can be configured to receive the additional abstraction program from any of the at least another computational node 110.

In one embodiment, the graph analytics appliance 130 can be embodied in a field-programmable gate array (FPGA). The graph data can be stored in a combination of volatile and non-volatile storage devices (140, 150) partitioned across the FPGA-based appliance. Attaching the graph analytics appliance 130 embodied in an FPGA directly to the volatile and non-volatile storage devices (140, 150) alleviates the potential bottleneck in the network link 320 between the volatile and non-volatile storage devices (140, 150) and the computational nodes 110, because only those vertices and edges matching a query, as embodied in the filtered data, are returned to the host or hosts represented by the nodes 110.

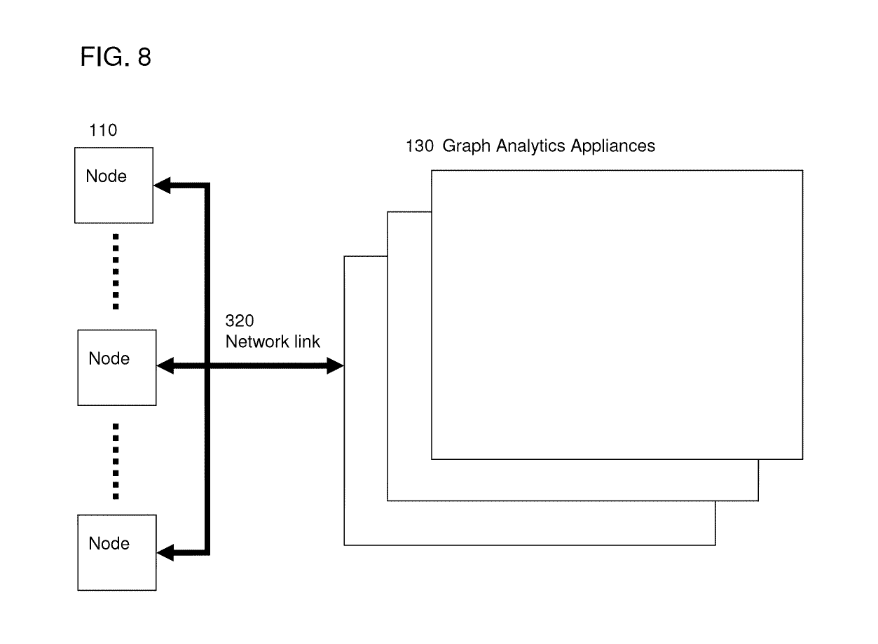

Referring to FIG. 8, the abstraction program compiler can reside in one of the at least one computational node 110, and can generate a plurality of abstraction programs from the query request, which can be subsequently distributed to a plurality of graph analytics appliances 130 that are connected in parallel to the network link 320. Each of the plurality of graph analytics appliances 130 can be configured to receive from the at least one computational node 100, and to run one of the abstraction programs. Additional filtered data can be returned from each of the plurality of graph analytics appliances 130 to the at least one computational node 110.

In one embodiment, multiple copies of the graph analytics appliances 130 are placed in parallel through the network link 320, which can be a low bandwidth low latency network, to copies of host computational nodes 110 placed in parallel. In such an organization, queries from any of the host computational nodes 110 may be routed to any of the graph analytics appliances 130 that are available at the time.

Graph analytic queries to run on the graph analytics appliance(s) 130 are discussed below. For illustrative purposes, two concrete queries on linked/graph data in targeted advertising and user recommendation are described. The SPARQL-like program abstraction described above can be employed. As is known in graph analytics, a vertex in a graph is associated with one or more attributes (for example, a person vertex may have a name as an attribute). An edge in a graph is also associated with one or more attributes.

The examples provided herein show a graph query both pictorially and in a SPARQL-like abstraction language that uses the X* extensions to permit a richer set of queries. A vertex marked “?V” indicates a wildcard match, matching any vertex and binding it to the variable name “V”. The matched vertex is returned as a response to the query. A vertex marked “data” indicates an exact match of a vertex that has an attribute value of “data”. Such vertices are not returned by the query. In response to a query, all sets of vertices and/or edges bound to variables are returned such that they match the requested query pattern.

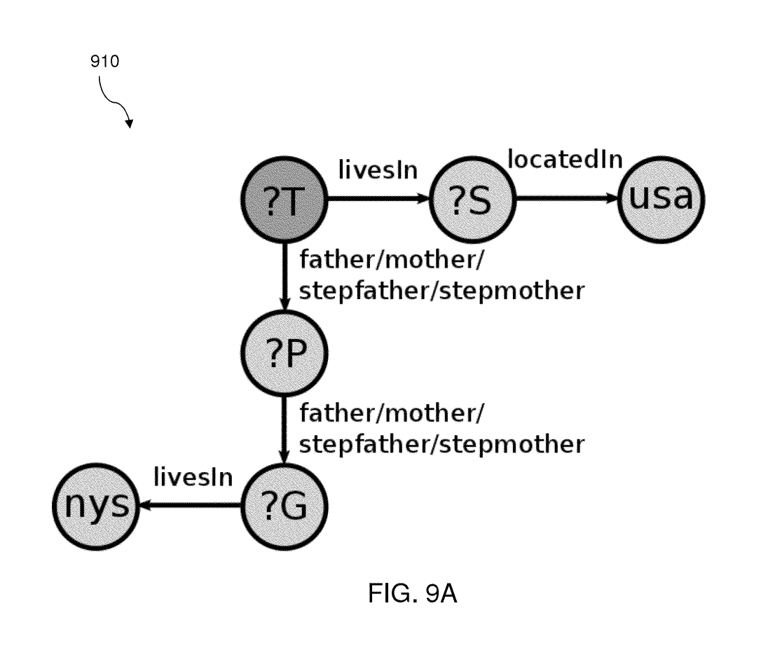

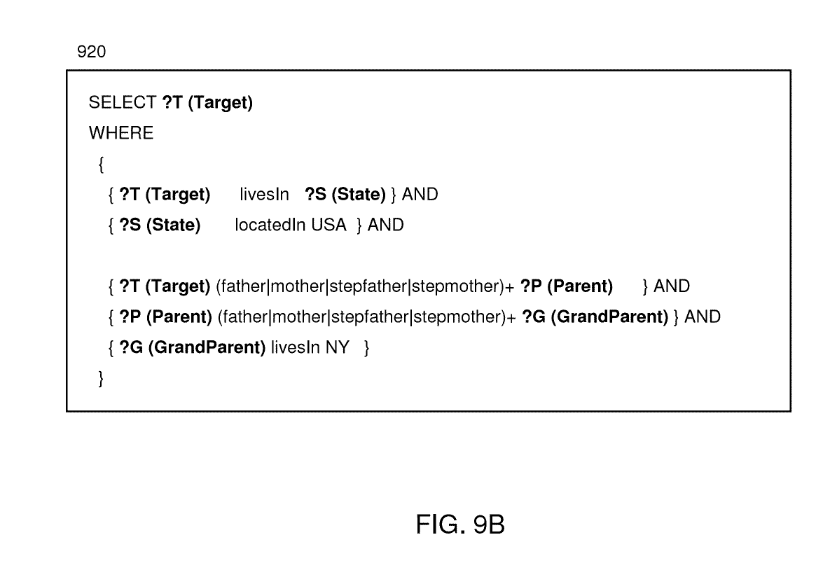

FIGS. 9A and 9B illustrate a pictorial representation 910 and a textual representation 920, respectively, of a query pattern for targeted advertising to grandchildren in the USA with grandparents living in the state of New York. This query seeks grandchildren (?T) living anywhere in the USA, having a grandparent (?G) living in the state of New York. In response to the query, only the grandchild vertex is returned. Note that this query can be specified without knowing who the exact persons are in the relationships between the grandchild and grandparent (the query only requires that there exist such a familial relationship). This is in part specified by regular expressions on edge attributes, for example, (father|mother)+, which requires that the attribute be either a ‘father’ or a ‘mother’ relationship. Such building blocks enable the specification of powerful queries, however, they also stress the underlying graph database management system.

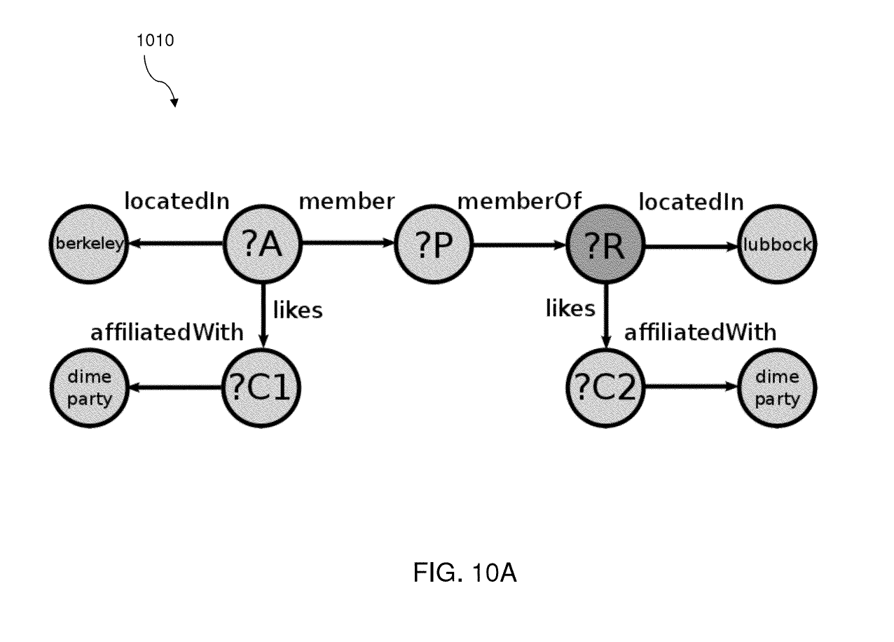

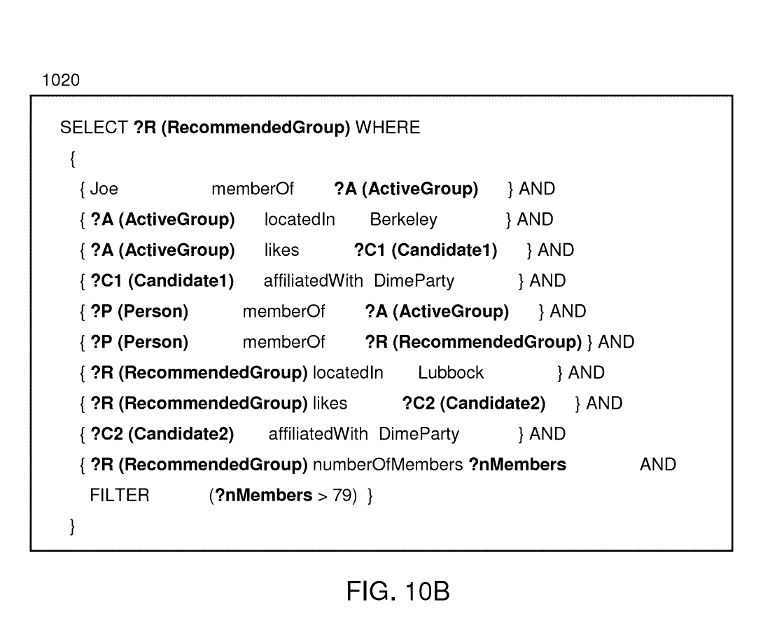

FIGS. 10A and 10B illustrate a pictorial representation 1110 and a textual representation 1120 of a query pattern for recommending similar groups. This is a more complex query that demonstrates the power of the analytics system according to an embodiment of the present disclosure. The query aims to find groups that a person named ‘Joe’ might be interested in. In particular, the query searches for groups (?R) in Lubbock that have a (like) relationship to some candidate (?C2) associated with the Dime Party. In addition, the group must also have at least one person (?P) who is also a member of a group (?A) that Joe is a member of, and which is also affiliated to some candidate (?C1) who is in the Dime Party. Finally, the newly recommended groups should have a sizable number of members (79). Such a complex query may find groups that are more relevant to the user ‘Joe’.

The methods of various embodiments of the present disclosure can be employed to reduce the number of concurrent threads required to hide I/O latency by moving processing close to storage. This feature is useful for applications with low concurrency.

The graph analytics appliance of various embodiments of the present disclosure can be used to filter vertices and edges of a large graph. Out of the large set of vertices and edges in the volatile/non-volatile store, the graph analytics appliance can compute an appropriate (which is likely to be much smaller than the fetched data) subset requested by the host. Thus, the graph analytics appliance of various embodiments of the present disclosure can reduce the data transferred to a general-purpose processor host via a low bandwidth link (through filtering), alleviating a performance bottleneck in the system.

The graph analytics appliance of various embodiments of the present disclosure can accept an abstracted code compiled from a high-level SPARQL-like (or any other related high-level language) program to support drop-in replacement of existing, unaccelerated graph DBMS that run on general-purpose processors with minimal modifications to existing application workflows. Further, the graph analytics appliance of various embodiments of the present disclosure can also support more complex analytics queries than SPARQL using the abstraction program.

While the disclosure has been described in terms of specific embodiments, it is evident in view of the foregoing description that numerous alternatives, modifications and variations will be apparent to those skilled in the art. Various embodiments of the present disclosure can be employed either alone or in combination with any other embodiment, unless expressly stated otherwise or otherwise clearly incompatible among one another. Accordingly, the disclosure is intended to encompass all such alternatives, modifications and variations which fall within the scope and spirit of the disclosure and the following claims.

What is claimed is:

1. A method of performing a query on a graph database, said method comprising:
providing a query request at a computational node comprising one or more processor units;
generating an abstraction program employing an abstraction program compiler, said abstraction program including programming instructions for performing parallel operations on graph data;
fetching data from a graph database to a graph analytics appliance according to instructions in said abstraction program;
generating filtered data that is less in data volume than said fetched data by running said graph analytics appliance; and
transmitting said filtered data from said graph analytics appliance to said computational node as an answer to said query request.

2. The method of claim 1, further comprising storing said fetched data in a volatile storage device in communication with said graph analytics appliance.

3. The method of claim 2, wherein said fetching of said data from said graph database to said graph analytics appliance comprises fetching said data directly from said graph database to said graph analytics appliance prior to storing said fetched data in said volatile storage device.

4. The method of claim 2, wherein said fetching of said data from said graph database to said graph analytics appliance comprises fetching said data from said graph database through said volatile storage into said graph analytics appliance.

5. The method of claim 2, further comprising storing at least one temporary data structure generated from said fetched data prior to generation of said filtered data into said volatile storage device.

6. The method of claim 1, further comprising generating a plurality of input/output (I/O) requests from said graph analytics appliance to said graph database.

7. The method of claim 1, wherein said graph analytics appliance comprises a graph database management system (DBMS) engine including at least one processing unit therein and configured to receive said abstraction program from, and to transmit said filtered data to, said computational node.

8. The method of claim 7, further comprising:
sending input/output (I/O) requests from said graph DBMS engine to an input/output unit; and
relaying said I/O requests, employing a set of I/O peripheral devices, between said I/O unit and said graph database.

9. The method of claim 8, further comprising storing said fetched data in a volatile storage device in communication with said graph analytics appliance.

10. The method of claim 9, further comprising:
sending additional input/output (I/O) requests from said graph DBMS engine to another input/output unit in said graph analytics appliance; and
relaying said additional I/O requests, employing another set of I/O peripheral devices, between said another I/O unit and said volatile storage device.

11. The method of claim 1, wherein said abstraction program comprises a plurality of parallel threads for running said requested query.

12. The method of claim 11, wherein each of said plurality of parallel threads includes an instruction for operating on no more than one vertex in a graph in said graph database.

13. The method of claim 12, wherein said plurality of parallel threads comprises:
first threads configured to operate on a single vertex and at least one edge in said graph; and
second threads configured to operate only on a single vertex in said graph.

14. The method of claim 1, wherein said computational node receives or generates said query request in a form of a structured query language.

15. The method of claim 14, wherein said abstraction program compiler generates said abstraction program in an assembly language for execution on at least one processing unit in said graph analytics appliance.

16. The method of claim 15, wherein each of said at least one processing unit is a reduced instruction set computing (RISC) processor unit.

17. The method of claim 1, further comprising:
providing another computational node comprising one or more additional processor units;
transmitting another query request to said another computational node; and
generating another abstraction program employing another abstraction program compiler residing on said another computational node, wherein said graph analytics appliance receives said another abstraction program from said another computational node.

18. The method of claim 1, further comprising generating, employing said abstraction program compiler, at least another abstraction program from said query request, wherein said apparatus further comprises at least another graph analytics appliance, wherein each of said another graph analytics appliance runs one of said at least another abstraction program, and returns additional filtered data to said computational node.

19. The method of claim 1, wherein said graph analytics appliance provides a first bandwidth for data transmission between said computational node and said graph analytics appliance and provides a second bandwidth for data transmission between said graph database and said graph analytics appliance, wherein said second bandwidth is greater than said first bandwidth.

20. The method of claim 19, wherein said second bandwidth is greater than said first bandwidth at least by a factor of 10.
